(19) United States
(12) Patent Application Publication
(10) Pub. No.: US 2025/0105576 A1
(43) Pub. Date: Mar. 27, 2025

(54) OPTICAL PULSE STRETCHER, LASER DEVICE, AND ELECTRONIC DEVICE MANUFACTURING METHOD

(71) Applicant: Gigaphoton Inc., Tochigi (JP)

(72) Inventors: Masanori YASHIRO, Oyama-shi (JP); Ryouta KUJIRA, Oyama-shi (JP)

(73) Assignee: Gigaphoton Inc., Tochigi (JP)

(21) Appl. No.: 18/797,561

(22) Filed: Aug. 8, 2024

(30) Foreign Application Priority Data
Sep. 26, 2023 (JP) 2023-163179

(51) Int. Cl. H01S 3/00; H01S 3/034

(52) U.S. Cl. CPC H01S 3/0057; H01S 3/034

(57) ABSTRACT

An optical pulse stretcher includes a beam splitter separating laser light incident on an optical surface thereof into reflection laser light and transmission laser light, a holder fixing the beam splitter with the optical surface of the beam splitter inclined with respect to an optical path axis of the incident laser light, mirrors guiding the reflection laser light to the beam splitter, and a slide mechanism moving the beam splitter in a direction parallel to the optical surface. The slide mechanism includes a slide plate to which the holder is coupled, and a case which holds the slide plate in a movable manner in a slide direction with respect to a base plate on which the mirrors are arranged. The case includes a threaded hole having an internal thread formed on an inner circumference thereof. The slide plate includes a through hole at a position corresponding to the threaded hole.

### CROSS-REFERENCE TO RELATED APPLICATIONS

The present application claims the benefit of Japanese Patent Application No. 2023-163179, filed on Sep. 26, 2023, the entire contents of which are hereby incorporated by reference.

### BACKGROUND

### 1. Technical Field

The present disclosure relates to an optical pulse stretcher, a laser device, and an electronic device manufacturing method.

### 2. Related Art

Recently, in a semiconductor exposure apparatus, improvement in resolution has been desired for miniaturization and high integration of semiconductor integrated circuits. For this purpose, an exposure light source that outputs light having a shorter wavelength has been developed. For example, as a gas laser device for exposure, a KrF excimer laser device for outputting laser light having a wavelength of about 248 nm and an ArF excimer laser device for outputting laser light having a wavelength of about 193 nm are used.

The KrF excimer laser device and the ArF excimer laser device each have a large spectral line width of about 350 to 400 μm in natural oscillation light. Therefore, when a projection lens is formed of a material that transmits ultraviolet rays such as KrF laser light and ArF laser light, there is a case in which chromatic aberration occurs. As a result, the resolution may decrease. Then, a spectral line width of laser light output from the gas laser device needs to be narrowed to the extent that the chromatic aberration can be ignored. For this purpose, there is a case in which a line narrowing module (LNM) including a line narrowing element (etalon, grating, and the like) is provided in a laser resonator of the gas laser device to narrow a spectral line width. In the following, a gas laser device with a narrowed spectral line width is referred to as a line narrowing gas laser device.

### LIST OF DOCUMENTS

### Patent Documents

Patent Document 1: Japanese Patent Application Publication No. 2000-130113
Patent Document 2: U.S. Pat. No. 9,322,934
Patent Document 3: Japanese Patent No. 5352278
Patent Document 4: Japanese Patent Application Publication No. 2015-155933

### SUMMARY

An optical pulse stretcher according to an aspect of the present disclosure includes a beam splitter configured to separate laser light incident on an optical surface thereof into reflection laser light and transmission laser light, a holder configured to fix the beam splitter with the optical surface of the beam splitter inclined with respect to an optical path axis of the incident laser light, a plurality of mirrors configured to guide the reflection laser light to the beam splitter, and a slide mechanism configured to move the beam splitter in a direction parallel to the optical surface. Here, the slide mechanism includes a slide plate to which the holder is coupled, and a case which holds the slide plate in a movable manner in a slide direction with respect to a base plate on which the plurality of mirrors are arranged. The case includes a threaded hole having an internal thread formed on an inner circumference thereof, and the slide plate includes a through hole at a position corresponding to the threaded hole.

A laser device according to an aspect of the present disclosure includes a pair of electrodes configured to cause discharge to occur, and an optical pulse stretcher configured to extend a pulse width of pulse laser light generated by the discharge having occurred between the electrodes. Here, the optical pulse stretcher includes a beam splitter configured to separate laser light incident on an optical surface thereof into reflection laser light and transmission laser light, a holder configured to fix the beam splitter with the optical surface of the beam splitter inclined with respect to an optical path axis of the incident laser light, a plurality of mirrors configured to guide the reflection laser light to the beam splitter, and a slide mechanism configured to move the beam splitter in a direction parallel to the optical surface. The slide mechanism includes a slide plate to which the holder is coupled, and a case which holds the slide plate in a movable manner with respect to a base plate on which the plurality of mirrors are arranged. The case includes a threaded hole, and the slide plate includes a through hole at a position corresponding to the threaded hole.

An electronic device manufacturing method according to an aspect of the present disclosure includes generating laser light with a pulse width extended using a laser device, outputting the laser light to an exposure apparatus, and exposing a photosensitive substrate to the laser light in the exposure apparatus to manufacture an electronic device. Here, the laser device includes a pair of electrodes configured to cause discharge to occur, and an optical pulse stretcher configured to extend the pulse width of pulse laser light generated by the discharge having occurred between the electrodes. The optical pulse stretcher includes a beam splitter configured to separate the laser light incident on an optical surface thereof into reflection laser light and transmission laser light, a holder configured to fix the beam splitter with the optical surface of the beam splitter inclined with respect to an optical path axis of the incident laser light, a plurality of mirrors configured to guide the reflection laser light to the beam splitter, and a slide mechanism configured to move the beam splitter in a direction parallel to the optical surface. The slide mechanism includes a slide plate to which the holder is coupled, and a case which holds the slide plate in a movable manner with respect to a base plate on which the plurality of mirrors are arranged. The case includes a threaded hole, and the slide plate includes a through hole at a position corresponding to the threaded hole.

### BRIEF DESCRIPTION OF THE DRAWINGS

Embodiments of the present disclosure will be described below merely as examples with reference to the accompanying drawings.

FIG. 1 is a view schematically showing the configuration of an exemplary laser device.

FIG. 2 is a perspective view showing another example of an optical pulse stretcher.

FIG. 3 is a schematic view showing a sliding mechanism of a beam splitter.

FIG. 4 is a schematic view showing the sliding mechanism of the beam splitter.

FIG. 5 is a view showing a state in which the beam splitter is arranged at a first position by the slide mechanism.

FIG. 6 is a view showing a state in which the beam splitter is arranged at a second position by the slide mechanism.

FIG. 7 is a sectional view taken along line 7-7 of FIG. 6.

FIG. 8 is a view for explaining a problem of the slide mechanism.

FIG. 9 is a schematic view showing the slide mechanism of the beam splitter according to a first embodiment.

FIG. 10 is a schematic view showing the slide mechanism of the beam splitter according to the first embodiment.

FIG. 11 is a view for explaining fixing of a case and a plate.

FIG. 12 is a schematic view showing the slide mechanism of the beam splitter according to a second embodiment.

FIG. 13 is a sectional view taken along line 13-13 of FIG. 12.

FIG. 14 is a diagram schematically showing a configuration example of an exposure apparatus.

### DESCRIPTION OF EMBODIMENTS

### Contents

1. Overview of laser device
   1.1 Configuration
   1.2 Operation
2. Another example of OPS
   2.1 Configuration
   2.2 Operation
   2.3 Effect
3. Slide mechanism of beam splitter
   3.1 Configuration
   3.2 Operation
   3.3 Effect
4. Problem
5. First embodiment
   5.1 Configuration
   5.2 Operation
   5.3 Effect
6. Second embodiment
   6.1 Configuration
   6.2 Operation
   6.3 Effect
7. Third embodiment
   7.1 Configuration
   7.2 Effect
8. Electronic device manufacturing method
9. Others

Hereinafter, embodiments of the present disclosure will be described in detail with reference to the drawings. The embodiments described below show some examples of the present disclosure and do not limit the contents of the present disclosure. Also, all configurations and operation described in the embodiments are not necessarily essential as configurations and operation of the present disclosure. Here, the same components are denoted by the same reference numeral, and duplicate description thereof is omitted.

### 1. Overview of Laser Device

### 1.1 Configuration

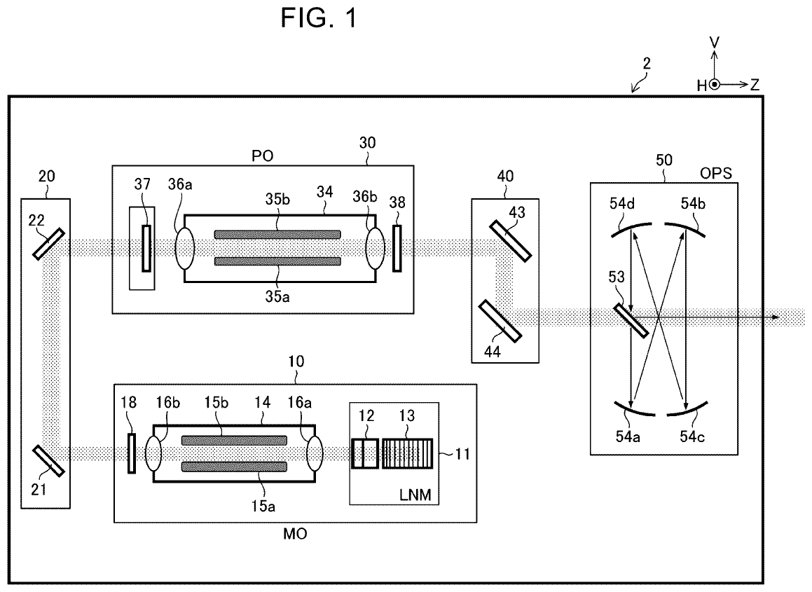

FIG. 1 is a view schematically showing the configuration of an exemplary laser device 2. The laser device 2 is an excimer laser device including a master oscillator (MO) 10, an MO beam steering unit 20, a power oscillator (PO) 30, a PO beam steering unit 40, and an optical pulse stretcher (OPS) 50.

The MO 10 includes an LNM 11, a chamber 14, and an output coupling mirror (OC) 18. The LNM 11 includes a prism beam expander 12 for narrowing the spectral line width and a grating 13. The prism beam expander 12 and the grating 13 are arranged in the Littrow arrangement so that an incident angle and a diffraction angle coincide with each other.

The OC 18 is a partial reflection mirror and is arranged to configure an optical resonator together with the LNM 11. The reflectance of the OC 18 may be, for example, between 40% and 60%.

The chamber 14 is arranged on the optical path of the optical resonator. The chamber 14 includes a pair of discharge electrodes 15a, 15b and two windows 16a, 16b through which laser light passes. An excimer laser gas is introduced into the chamber 14. The excimer laser gas includes, for example, an Ar gas or a Kr gas as a rare gas, an F₂ gas as a halogen gas, and an Ne gas as a buffer gas.

The MO beam steering unit 20 includes a high reflection mirror 21 and a high reflection mirror 22, and is arranged such that the pulse laser light output from the MO 10 enters the PO 30.

The PO 30 includes a rear mirror 37, a chamber 34, and an OC 38. The rear mirror 37 and the OC 38 configure an optical resonator, and the chamber 34 is arranged on the optical path of the optical resonator.

The configuration of the chamber 34 may be similar to that of the chamber 14. That is, the chamber 34 includes a pair of discharge electrodes 35a, 35b and two windows 36a, 36b through which the laser light passes. An excimer laser gas is introduced into the chamber 34. The rear mirror 37 is a partial reflection mirror having a reflectance of 50% to 90%. The OC 38 is a partial reflection mirror having a reflectance of 10% to 30%.

The PO beam steering unit 40 includes a high reflection mirror 43 and a high reflection mirror 44. These high reflection mirrors 43, 44 are arranged such that the pulse laser light output from the PO 30 enters the OPS 50.

The OPS 50 is an example of the “optical pulse stretcher” in the present disclosure. The OPS 50 includes a beam splitter 53 and four concave mirrors 54a, 54b, 54c, 54d. The beam splitter 53 is arranged on the optical path of the pulse laser light output from the PO beam steering unit 40. The beam splitter 53 is a partial reflection mirror that transmits a part of the pulse laser light of the incident pulse laser light and reflects the other part thereof. That is, the beam splitter 53 separates the pulse laser light incident thereon into reflection laser light and transmission laser light. The reflectance of the beam splitter 53 may be, for example, 60%. The beam splitter 53 causes the pulse laser light transmitted through the beam splitter 53 to be output from the laser device 2.

The four concave mirrors 54a to 54d configure a delay optical path of the pulse laser light reflected by a first surface of the beam splitter 53. The pulse laser light reflected by the first surface of the beam splitter 53 is reflected by the four concave mirrors 54a to 54d, and is incident again on the beam splitter 53.

The four concave mirrors 54a to 54d may be concave mirrors having substantially the same focal length. The focal length f of each of the concave mirrors 54a to 54d may correspond to, for example, the distance from the beam splitter 53 to the concave mirror 54a.

The concave mirror 54a and the concave mirror 54b are arranged such that the pulse laser light reflected by the first surface of the beam splitter 53 is reflected by the concave mirror 54a to be incident on the concave mirror 54b. The concave mirror 54a and the concave mirror 54b are arranged such that the pulse laser light reflected by the first surface of the beam splitter 53 is focused as a first image at magnification (1:1) equal to the image on the first plane of the beam splitter 53.

The concave mirror 54c and the concave mirror 54d are arranged such that the pulse laser light reflected by the concave mirror 54b is reflected by the concave mirror 54c to be incident on the concave mirror 54d. Further, the concave mirror 54d is arranged such that the pulse laser light reflected by the concave mirror 54d is incident on a second surface of the beam splitter 53 on the side opposite to the first surface. The concave mirror 54c and the concave mirror 54d are arranged such that the first image is focused on the second surface of the beam splitter 53 at 1:1 as a second image. The four concave mirrors 54a to 54d are an example of the “plurality of mirrors” in the present disclosure.

### 1.2 Operation

When discharge occurs in the chamber 14 of the MO 10, the laser gas is excited, and the pulse laser light line-narrowed by the optical resonator configured by the OC 18 and the LNM 11 is output from the OC 18. The pulse laser light is incident on the rear mirror 37 of the PO 30 as the seed light by the MO beam steering unit 20.

Discharge occurs in the chamber 34 in synchronization with the timing when seed light transmitted through the rear mirror 37 enters. As a result, the laser gas is excited, the seed light is amplified by the Fabry-Perot optical resonator configured by the OC 38 and the rear mirror 37, and the amplified pulse laser light is output from the OC 38. The pulse laser light output from the OC 38 enters the OPS 50 via the PO beam steering unit 40. The pulse width of the pulse laser light is extended by the OPS 50.

The pulse laser light having passed through the OPS 50 may pass through a monitor module (not shown) and enter a beam characteristic measurement device. The monitor module is a module that measures the pulse energy, spectral line width, wavelength, and the like. The beam characteristic measurement device is a module that measures the pointing, divergence, polarization degree, and the like. Although FIG. 1 shows an example in which the OPS 50 as one stage is provided, the laser device 2 may include OPSs as two or more stages. For example, one or more OPSs (not shown) may be arranged in series on the optical path of the pulse laser light output from the OPS 50.

### 2. Another Example of OPS

### 2.1 Configuration

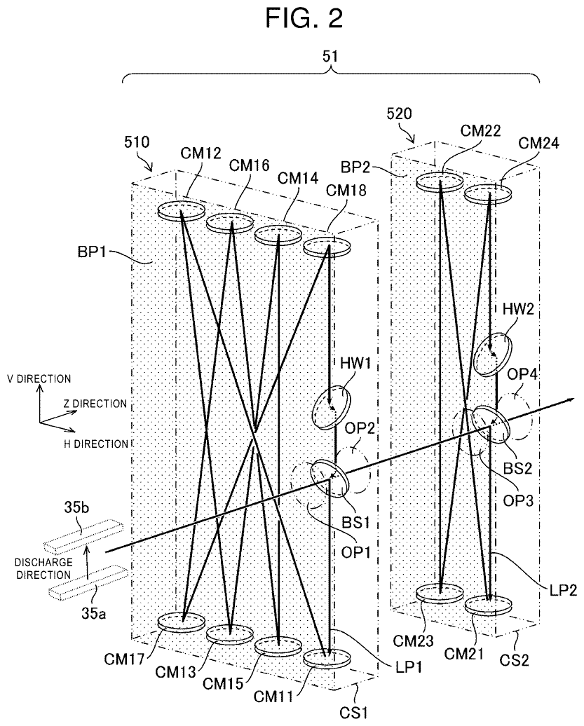

FIG. 2 is a perspective view showing another example of the optical pulse stretcher. Instead of the OPS 50 shown in FIG. 1, an OPS 51 having a two-stage configuration as shown in FIG. 2 may be employed.

The OPS 51 includes a first OPS module 510 and a second OPS module 520. The first OPS module 510 includes a beam splitter BS1, a loop optical path LP1, and a case CS1 including a base plate BP1. The loop optical path LP1 is a delay optical path configured by concave mirrors CM11 to CM18 and a halving window HW1.

The second OPS module 520 is configured by a beam splitter BS2, a loop optical path LP2, and a case CS2 including a base plate BP2. The loop optical path LP2 is a delay optical path configured by concave mirrors CM21 to CM24 and a halving window HW2.

Each optical element is held by a holder (not shown), and the holders are positioned on the base plates BP1, BP2, respectively. Each of the base plates BP1, BP2 may configure any surface of the corresponding case CS1, CS2, but in the example shown in FIG. 2, the base plates BP1, BP2 configure surfaces parallel to an HV plane on the front side of the cases CS1, CS2. The discharge direction of the discharge electrodes 35a, 35b is represented by the V direction, and a direction parallel to the optical path axis of the laser light entering the OPS 51 is represented by the Z direction. The direction perpendicular to both the V direction and the Z direction is represented by the H direction. The discharge electrodes 35a, 35b are an example of the “pair of electrodes” in the present disclosure.

Here, in the present specification, the term “orthogonal” or “perpendicular” is not limited to the case of being strictly orthogonal or perpendicular, and includes the of substantially concept being orthogonal or substantially perpendicular including a range of angular difference that is practically acceptable without losing technical significance, unless otherwise specified. Further, in the present specification, the term “parallel” is not limited to the case of being strictly parallel, and includes the concept of being substantially parallel including a range of angular difference that is practically acceptable without losing technical significance, unless otherwise specified.

Openings OP1, OP2 through which the laser light passes are formed in the case CS1. The opening OP1 is an entrance port of the laser light to the first OPS module 510, and the opening OP2 is an outlet port of the laser light from the first OPS module 510. Similarly, an opening OP3 which is an entrance port of the laser light and an opening OP4 which is an outlet port are formed in the case CS2.

The concave mirrors CM11 to CM18, CM21 to CM24 are arranged to face each other at both ends of the cases CS1, CS2 in the V direction. That is, the concave mirrors CM11, CM15, CM13, CM17 of the first OPS module 510 are arranged in this order in a direction parallel to the H direction on the bottom side of the case CS1, and the concave mirrors CM18, CM14, CM16, CM12 are arranged in this order in a direction parallel to the H direction on the top side of the case CS1. Thus, the concave mirror CM11 is arranged to face the concave mirror CM18 across the beam splitter BS1.

Similarly, the concave mirrors CM15, CM13, CM17 are arranged to face the concave mirrors CM14, CM16, CM12, respectively. The loop optical path LP1 is configured such that the light reflected by the beam splitter BS1 returns to the beam splitter BS1 after being reflected by the concave mirrors CM11, CM12, CM13, CM14, CM15, CM16, CM17, CM18 in this order.

Further, the concave mirrors CM21, CM23 of the second OPS module 520 are arranged in this order in a direction parallel to the H direction on the bottom side of the case CS2, and the concave mirrors CM24, CM22 are arranged in this order in a direction parallel to the H direction on the top side of the case CS2. Thus, the concave mirror CM21 is arranged to face the concave mirror CM24 across the beam splitter BS2, and the concave mirror CM23 is arranged to face the concave mirror CM22. The loop optical path LP2 is configured such that the light reflected by the beam splitter BS2 returns to the beam splitter BS2 after being reflected by the concave mirrors CM21, CM22, CM23, CM24 in this order.

Each of the beam splitters BS1, BS2 is located on the optical path of the pulse laser light output from the PO beam steering unit 40.

Each of the halving windows HW1, HW2 is arranged between the corresponding last concave mirror CM18, CM24 in the loop optical path LP1, LP2 and the corresponding beam splitter BS1, BS2.

### 2.2 Operation

The pulse laser light output from the PO 30 passes through the opening OP1 and enters the beam splitter BS1. A part of the pulse laser light is transmitted and the remaining part thereof is reflected. The pulse laser light reflected by the beam splitter BS1 propagates through the loop optical path LP1 and passes through the halving window HW1 to be accurately multiplexed with the pulse laser light transmitted through the beam splitter BS1.

A part of the pulse laser light incident on the beam splitter BS1 again is transmitted, and the remaining part thereof is reflected. The reflected pulse laser light is multiplexed with the pulse laser light transmitted through the beam splitter BS1 without passing through the loop optical path LP1. As described above, the pulse laser light passing through the loop optical path LP1 is sequentially superimposed on the pulse laser light transmitted through the beam splitter BS1, whereby the pulse width is extended. The pulse laser light passing through the loop optical path LP1 is prevented, by passing through the halving window HW1, from having the optical path thereof deviated every time it propagates through the loop optical path LP1.

Similarly, the pulse laser light output from the first OPS module 510 is incident on the beam splitter BS2, and the pulse width is further extended in the process of propagating through the loop optical path LP2.

### 2.3 Effect

According to the OPS 51 shown in FIG. 2, the pulse width can be greatly extended by the loop optical path LP1 of the first stage and the loop optical path LP2 of the second stage, and occurrence of speckle can be suppressed. Further, since the pulse width is extended, an energy value per unit time radiated to an optical system at a subsequent stage is decreased, and deterioration of the optical system is suppressed.

### 3. Slide Mechanism of Beam Splitter

### 3.1 Configuration

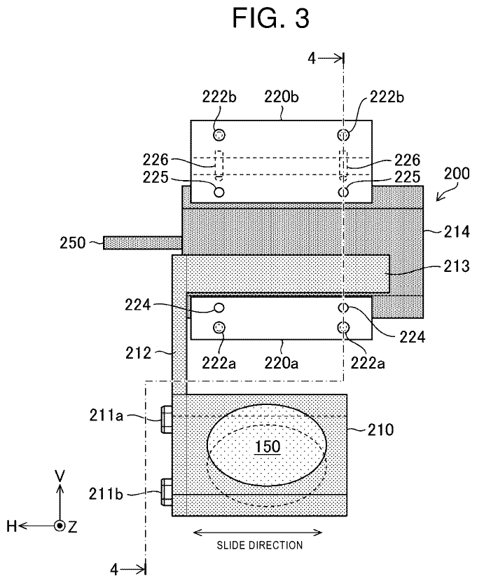

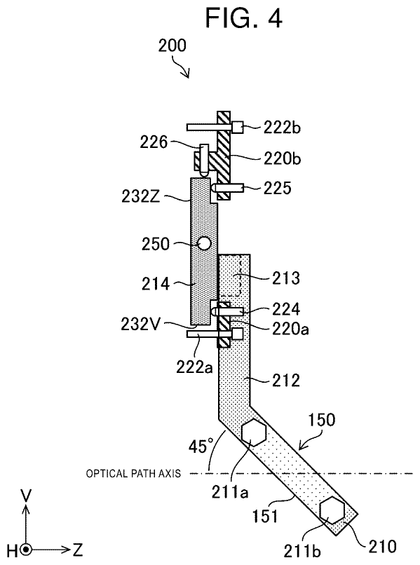

FIGS. 3 and 4 are schematic views showing a slide mechanism of the beam splitter. FIG. 3 is a view viewed from a direction (Z direction) parallel to the optical path axis of the laser light transmitted through a beam splitter 150. FIG. 4 is a partial sectional view taken along line 4-4 of FIG. 3. The H direction is a direction parallel to an optical surface 151 of the beam splitter 150.

The slide mechanism 200 includes a beam splitter (BS) holder 210 for holding the beam splitter 150, plates 212, 213, 214, and plate holders 220a, 220b. The beam splitter 150 may be either the beam splitter 53 shown in FIG. 1 or the beam splitters BS1, BS2 shown in FIG. 2.

The beam splitter 150 is fixed to the BS holder 210. The beam splitter 150 is arranged such that the optical surface 151 on which the laser light is incident is inclined by 45 degrees with respect to the optical path axis of the pulse laser light output from the PO beam steering unit 40.

The BS holder 210 is fixed to the plate 212 using BS holder fixing screws 211a, 211b provided on the side surface side of the BS holder 210. Each of the BS holder fixing screws 211a, 211b has an axial center parallel to the optical surface 151 of the beam splitter 150. The plate 212 is fixed to the plate 213. The plate 213 is fixed to the plate 214. Thus, the BS holder 210 is coupled to the plate 214.

The plate 214 has a V-direction reference surface 232V and a Z-direction reference surface 232Z. The V-direction reference surface 232V is a surface perpendicular to the V direction and defining a reference position of the beam splitter 150 in the V direction. The Z-direction reference surface 232Z is a surface perpendicular to the Z direction and defining the reference position of the beam splitter 150 in the Z direction. The plate 214 is an example of a “slide plate” in the present disclosure.

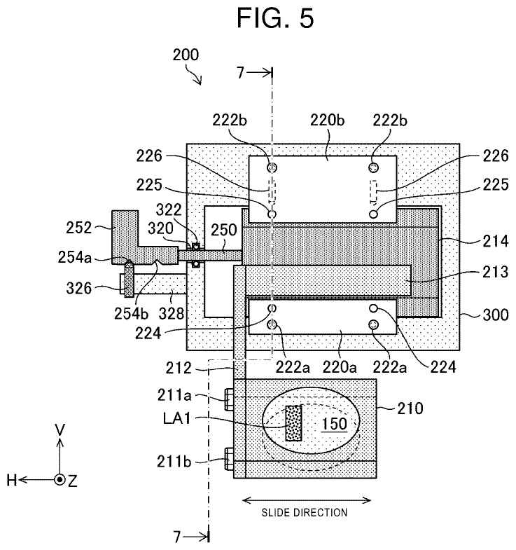

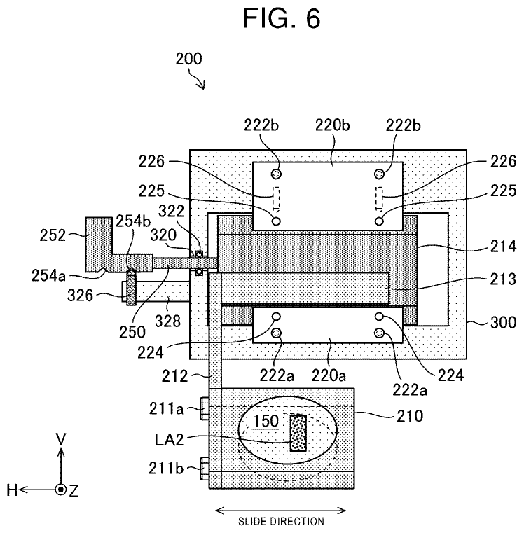

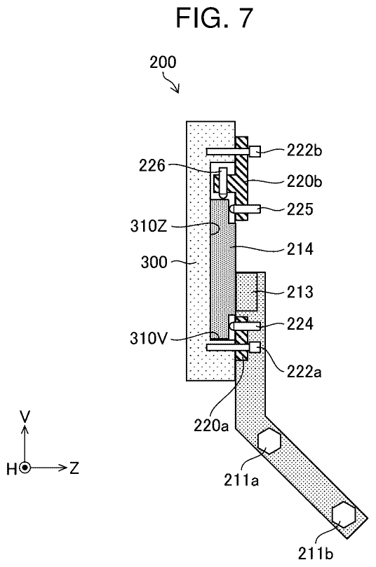

FIG. 5 is a view showing a state in which the beam splitter 150 is arranged at a first position by the slide mechanism 200. FIG. 6 is a view showing a state in which the beam splitter 150 is arranged at a second position by the slide mechanism 200. FIG. 7 is a partial sectional view taken along line 7-7 of FIG. 5.

The plate holders 220a, 220b are fixed to the case 300 using bolts 222a, 222b. The plate holders 220a, 220b causes the plate 214 to be in contact with reference surfaces 310V, 310Z of the case 300, so that the plate 214 is held in a slidable manner along the reference surfaces 310V, 310Z. The reference surface 310V is a case reference surface perpendicular to the V direction. The reference surface 310Z is a case reference surface perpendicular to the Z direction.

The case 300 may be the case CS1 or the case CS2 shown in FIG. 2. The reference surface 310V and the reference surface 310Z may be formed on the base plate BP1 or the base plate BP2 shown in FIG. 2. The plate 214 is pressed by a reaction force of springs (not shown) arranged on plungers 224, 225, 226, and the like so that the V-direction reference surface 232V and the Z-direction reference surface 232Z of the plate 214 are reliably brought into contact with the reference surface 310V and the reference surface 310Z of the case 300, respectively.

The plunger 224 acting in the Z direction is attached to the plate holder 220a. The plunger 225 acting in the Z direction and the plunger 226 acting in the V direction are attached to the plate holder 220b.

The plungers 224, 225 urge the plate 214 in the direction from the right to the left in FIG. 7 (−Z direction), and press the Z-direction reference surface 232Z (see FIG. 4) of the plate 214 against the reference surface 310Z of the case 300. The plunger 226 urges the plate 214 in the direction from the upside to the downside in FIG. 7 (−V direction), and presses the V-direction reference surface 232V (see FIG. 4) of the plate 214 against the reference surface 310V of the case 300.

Due to the reaction force of the plungers 224, 225, 226, the V-direction reference surface 232V and the Z-direction reference surface 232Z are brought into contact with the reference surface 310V and the reference surface 310Z of the case 300, respectively, and the plate 214 can slide along the reference surface 310V and the reference surface 310Z. That is, the plate 214 is slidable in the ±H direction with the position in the V direction and the Z direction maintained. The ±H direction may be referred to as a slide direction.

A rod 250 extending in the H direction is connected to the plate 214 so that the plate 214 can be moved in the slide direction by applying a force to the plate 214 from the outside of the case 300. The rod 250 extends to the outside of the case 300 as penetrating through a through hole 320 formed in the case 300. An O-ring 322 for sealing is arranged in the through hole 320 to maintain airtightness in the case 300, and the rod 250 is movable in the slide direction in contact with the O-ring 322. A handle 252 is provided at an end of the rod 250 extending to the outside of the case 300.

Further, the handle 252 is formed with positioning grooves 254a, 254b that define a position in the slide direction. The present embodiment shows an example in which two positioning grooves 254a, 254b corresponding to two positions being the first position (FIG. 5) and the second position (FIG. 6) are provided, but the positioning grooves corresponding to three or more positions may be provided. The positioning groove 254a is an example of the “first recessed portion” in the present disclosure, the positioning groove 254b is an example of the “second recessed portion” in the present disclosure, and the positioning grooves 254a, 254b are an example of the “plurality of recessed portions” in the present disclosure.

A plunger 326 used for positioning in the slide direction is arranged at the case 300. The plunger 326 is fixed to a support member 328 extending from the case 300. The plunger 326 is engaged with either one of the positioning groove 254a and the positioning groove 254b to restrict the position of the plate 214 in the slide direction and perform positioning. The plunger 326 is an example of the “positioning plunger” in the present disclosure. The positioning mechanism including the positioning groove 254a, the positioning groove 254b, and the plunger 326 is an example of the “positioning mechanism” in the present disclosure. The handle 252 having the positioning groove 254a and the positioning groove 254b is an example of the “engaged member” in the present disclosure.

### 3.2 Operation

The plate 214 slides in a direction perpendicular to the optical path axis (Z axis) and parallel to the optical surface 151 of the beam splitter 150, so that the laser irradiation position on the beam splitter 150 can be shifted while the orientation of the optical surface 151 is maintained. The direction parallel to the optical surface 151 of the beam splitter 150 may be a direction intersecting a maintenance surface of a housing (not shown) of the laser device 2, or may be a direction passing through a maintenance opening provided in the maintenance surface. The maintenance surface is a surface perpendicular to the H direction.

As shown in FIG. 5, by engaging the plunger 326 with the positioning groove 254a of the handle 252, the plate 214 and the beam splitter 150 which is integrally slidable with the plate 214 are positioned at the first position.

Further, a field engineer or the like operates the handle 252 to pull out the rod 250 from the state of FIG. 5, and engages the plunger 326 with the positioning groove 254b of the handle 252 as shown in FIG. 6, whereby the plate 214 and the beam splitter 150 are positioned at the second position.

It is preferable to set a movement amount (slide amount) in the slide direction by the slide mechanism 200 so that an irradiation region LA1 of the laser light with respect to the beam splitter 150 at the first position and the irradiation region LA2 of the laser light with respect to the beam splitter 150 at the second position do not overlap.

For example, the laser device 2 is first used with the beam splitter 150 being at the first position, and when optical characteristics of a part of the region of the beam splitter 150 are deteriorated due to the laser irradiation on the beam splitter 150, the beam splitter 150 is moved to the second position so that another region that is not deteriorated is irradiated with the laser light.

### 3.3 Effect

The beam splitter 150 is deteriorated (energy transmittance is deteriorated) due to the laser irradiation. According to the slide mechanism 200, by moving the beam splitter 150, the laser irradiation position with respect to the beam splitter 150 can be shifted, and a position not deteriorated can be irradiated with the laser light. Thus, by using the beam splitter 150 while avoiding the deteriorated position, the frequency of replacement can be reduced, and a long lifetime of the beam splitter 150 can be expected. The number of times of sliding for shifting the laser irradiation position depends on the size of the beam splitter 150 and the size of the laser irradiation area, but is typically about 2 to 5 time.

The influence of the change in the element arrangement angle of the beam splitter 150 on the output light is small, and realignment for sliding only the beam splitter 150 is not necessary.

As a result, it is not necessary to replace the OPS module even when the beam splitter 150 is partially deteriorated, and the module usage time can be extended several times and the running cost can be suppressed.

Further, according to the slide mechanism 200, the beam splitter 150 can be slid while maintaining the sealing in the case 300, and downtime associated with the maintenance work can be reduced.

### 4. Problem

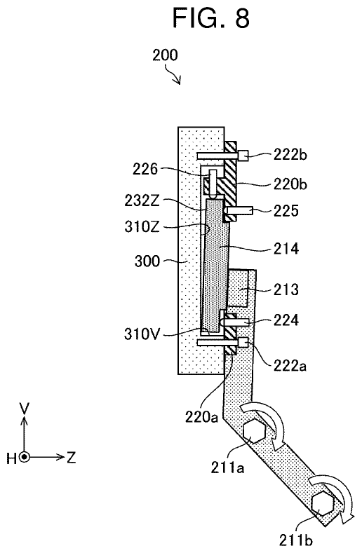

FIG. 8 is a view for explaining a problem of the slide mechanism, and is a partial sectional view similar to FIG. 7. When the BS holder 210 is fixed to the plate 212, the BS holder fixing screws 211a, 211b on the side surface of the BS holder 210 are tightened with specified torque. As shown in FIG. 8, when torque is applied to the BS holder fixing screws 211a, 211b in the clockwise direction, which is the tightening direction, a force acts on the plate 214 with the case 300 being as a fulcrum in a direction away from the case 300, and the plunger 225 may contract due to the force. As a result, a gap may occur between the Z direction reference surface 232Z of the plate 214 and the reference surface 310Z of the case 300.

When such a gap occurs, the beam splitter 150 is not held at a predetermined position and a predetermined angle with respect to the reference surface 310Z. Therefore, it is difficult to adjust or confirm the optical axis while applying torque to the BS holder fixing screws 211a, 211b.

Therefore, an object of the present invention is to suppress an angle deviation of the beam splitter 150 even when a rotational force is applied to the plate 214 as in a case when the BS holder 210 is replaced.

### 5. First Embodiment

### 5.1 Configuration

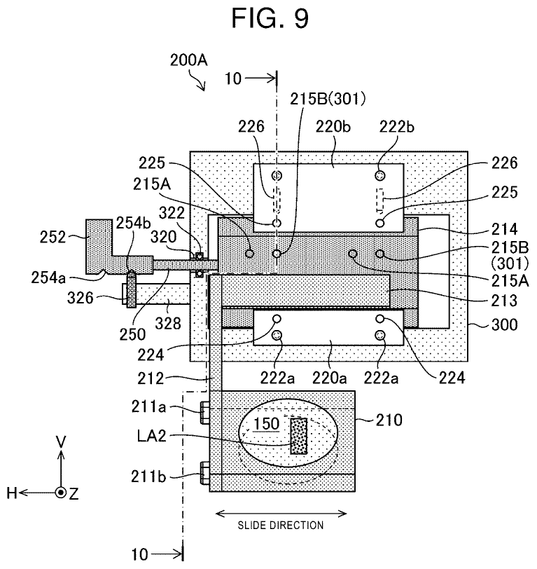

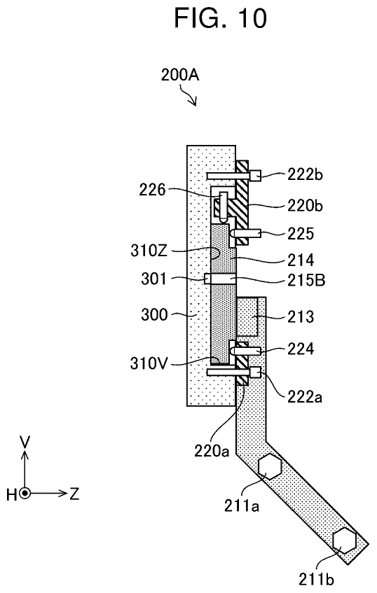

FIGS. 9 and 10 are schematic views showing the slide mechanism of the beam splitter according to a first embodiment. FIG. 9 is a view viewed from a direction (Z direction) parallel to the optical path axis of the laser light transmitted through the beam splitter 150, and FIG. 10 is a partial sectional view taken along line 10-10 of FIG. 9.

The case 300 includes a non-through tapped hole 301 having an internal thread formed on the inner circumference thereof in the reference surface 310Z with which the plate 214 comes into contact. The position of the tapped hole 301 in the V direction is a position between a hole into which the bolt 222a is inserted and the hole into which the bolt 222b is inserted in the case 300. The position of the tapped hole 301 in the H direction is the position same as the hole into which the bolt 222a is inserted and the hole into which the bolt 222b is inserted in the case 300. The tapped hole 301 is an example of the “threaded hole” in the present disclosure.

The plate 214 includes a through hole 215B at a position corresponding to the tapped hole 301. The through hole 215B penetrates from the surface to which the plate 213 is fixed to the Z-direction reference surface 232Z (see FIG. 4) in the Z direction. The through hole 215B is a non-threaded hole without having an internal thread formed on the inner circumference thereof, and has a diameter larger than that of the tapped hole 301. The position corresponding to the tapped hole 301 refers to a position at which the through hole 215B and the tapped hole 301 are coaxial with each other when the beam splitter 150 is arranged at the second position in the example of FIG. 9. The through hole 215B is an example of the “through hole” in the present disclosure.

In the example shown in FIG. 9, the case 300 is provided with two tapped holes 301, and the plate 214 is provided with two through holes 215B corresponding to the two tapped holes 301. Thus, a plurality of pairs of the tapped hole 301 and the through hole 215B may be arranged.

The plate 214 may also include a through hole 215A at a position corresponding to the tapped hole 301 when the beam splitter 150 is arranged at the first position. The through hole 215A penetrates from the surface to which the plate 213 is fixed to the Z-direction reference surface 232Z in the Z direction. The through hole 215A is a non-threaded hole without having an internal thread formed on the inner circumference thereof, and has a diameter larger than that of the tapped hole 301.

A through hole provided in the plate 214 may have an elongated hole shape extending in the H direction so as to be located at a position corresponding to the tapped hole 301 even in any case in which the beam splitter 150 is at any position from the first position to the second position.

### 5.2 Operation

Prior to applying torque to the BS holder fixing screws 211a, 211b, the field engineer or the like fixes the case 300 and the plate 214 to prevent a gap from occurring between the Z-direction reference surface 232Z of the plate 214 and the reference surface 310Z of the case 300 even when torque is applied.

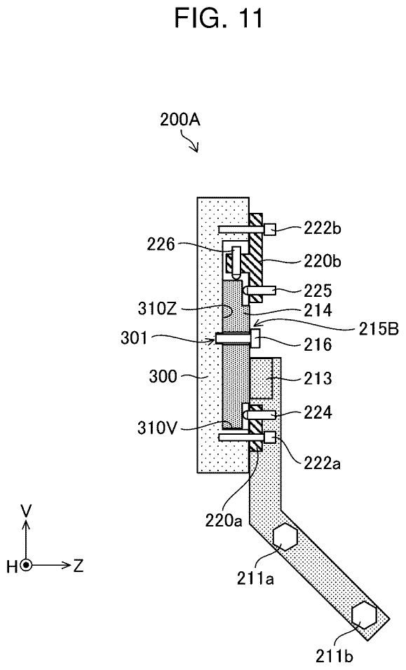

FIG. 11 is a view for explaining the fixing of the case 300 and the plate 214. As shown in FIG. 11, a slide plate fixing screw 216 is fastened to the tapped hole 301 via the through hole 215B, whereby the case 300 and the plate 214 are fixed to each other. The slide plate fixing screw 216 may be fastened to the tapped hole 301 via the through hole 215A.

Next, the field engineer or the like fixes the BS holder 210 to the plate 214 by applying torque to the BS holder fixing screws 211a, 211b.

Finally, the field engineer or the like removes the slide plate fixing screw 216. This allows the beam splitter 150 to slide.

### 5.3 Effect

According to the configuration of the first embodiment, the angle deviation of the beam splitter 150, that is, the optical axis deviation of the beam splitter 150 when torque is applied to the BS holder fixing screws 211a, 211b is reduced. Therefore, assembly adjustment and confirmation of the optical axis while applying torque are facilitated.

### 6. Second Embodiment

### 6.1 Configuration

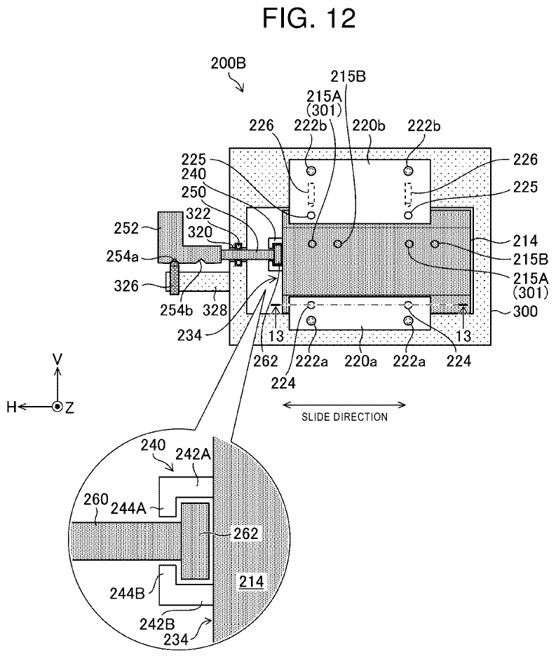

FIG. 12 is a schematic view showing the slide mechanism of the beam splitter according to a second embodiment. A slide mechanism 200B includes a plate 240 and a rod 260. In FIG. 12, the beam splitter 150, the BS holder 210, the BS holder fixing screws 211a, 211b, the plate 212, and the plate 213 are not shown.

The plate 240 is fixed to a side surface 234, which is a plane parallel to a VZ plane, of the plate 214 with screws (not shown). The plate 240 includes two erecting portions 242A, 242B. The erecting portion 242A includes a hook portion 244A directed toward the erecting portion 242B at a tip end thereof. The erecting portion 242B includes a hook portion 244B directed toward the erecting portion 242A at a tip end thereof. The plate 240 is an example of the “plate portion” in the present disclosure.

The rod 260 penetrates through the through hole 320 formed in the case 300. The handle 252 is provided at an end of the rod 260 at the outside of the case 300. A circular flange portion 262 protruding radially outward of the rod 260 is provided at an end of the rod 260 at the inside of the case 300, and a tip end of the rod 260 has a T-shaped cross section.

The distance between the hook portion 244A and the hook portion 244B of the plate 240 is larger than the diameter of the rod 260 and smaller than the diameter of the flange portion 262. The length of the erecting portions 242A, 242B of the plate 240 in the H direction is larger than the length of the flange portion 262 in the H direction. The rod 260 penetrates between the hook portion 244A and the hook portion 244B of the plate 240, and the flange portion 262 is held with a gap in a space surrounded by the plate 240 and the plate 214. Thus, the rod 260 is coupled to the plate 214 in a floating manner, and a slide axis of the plate 214 is made uniaxial. The hook portion 244 and the flange portion 262 are examples of the “transmission member” in the present disclosure.

### 6.2 Operation

When the field engineer or the like operates the handle 252 to pull out the rod 260 in a direction from the right to the left in FIG. 12 (H direction), the flange portion 262 of the rod 260 is hooked by the hook portions 244A, 244B of the plate 240, and the plate 240 transmits the displacement of the rod 260 in the H direction to the plate 214. As a result, the field engineer or the like can move the plate 214 in the H direction.

Further, when the field engineer or the like operates the handle 252 to push the rod 260 in the direction from the left to the right in FIG. 12 (−H direction), the flange portion 262 of the rod 260 abuts against the side surface 234 of the plate 214 and transmits the displacement of the rod 260 in the −H direction to the plate 214. As a result, the field engineer or the like can move the plate 214 in the −H direction.

Further, the transmission of the displacement of the rod 260 in a direction different from the ±H direction to the plate 214 is restricted.

### 6.3 Effect

Owing to that the plate 214 and the rod 260 are in a floating manner, displacement in the slide direction of the rod 260 is transmitted to the plate 214, and displacement in a direction different from the slide direction of the rod 260 is not transmitted. As a result, the slide axis becomes one axis in the reference surface 310V. Therefore, it is possible to absorb the misalignment and the angle deviation between the rod 260 and the reference surface 310V of the case 300. Thus, it is possible to expect improvement in pushing and pulling operability such as light operability, and reduction in angle deviation of the beam splitter at the time of pushing and pulling.

### 7. Third Embodiment

### 7.1 Configuration

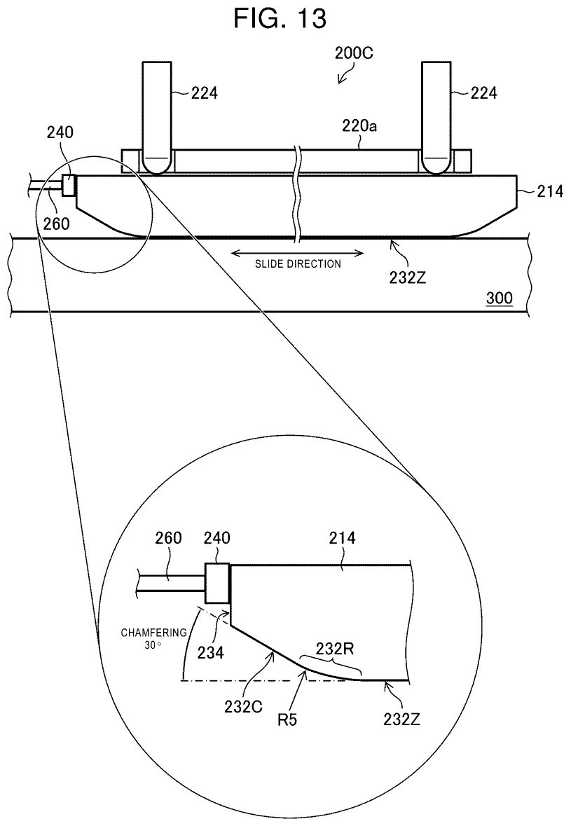

FIG. 13 is a schematic view showing the slide mechanism of the beam splitter according to a third embodiment, and is a sectional view taken along line 13-13 of FIG. 12. Here, FIG. 13 shows only periphery of both ends of the plate 214.

As shown in FIG. 13, in a slide mechanism 200C, the shape of both ends in the slide direction of the Z-direction reference surface 232Z, which is a contact surface with the case 300, of the plate 214 is chamfered by 30 degrees and has a curvature radius of R5.

That is, the plate 214 includes an inclined surface 232C at both ends in the slide direction of the Z-direction reference surface 232Z. The inclined surface 232C is a surface inclined with respect to the slide direction, and connects the Z-direction reference surface 232Z and the side surface 234. The angle of the inclined surface 232C with respect to the slide direction is 30 degrees. The angle of the inclined surface 232C with respect to the slide direction is preferably 10 degrees or more and 45 degrees or less.

Further, the plate 214 includes a curved surface 232R having a radius of curvature between the Z-direction reference surface 232Z and the inclined surface 232C. The radius of curvature of the curved surface 232R is 5 mm. The radius of curvature of the curved surface 232R is preferably 3 mm or more and 15 mm or less.

Further, the material of the plate 214 may be SUS440C having a relatively high hardness. As described above, the Z-direction reference surface 232Z and the V-direction reference surface 232V pressed by the plungers 224, 225, 226 may be configured of a hard material, for example, stainless steel. Further, the plate 214 may be subjected to quenching or coating.

### 7.2 Effect

According to the slide mechanism 200C, since the push-pull resistance in the slide direction is reduced owing to the inclined surface 232C and the curved surface 232R, it is possible to suppress vibration at the time of pushing and pulling. Therefore, it is possible to expect further reduction in angle deviation of the beam splitter 150 at the time of pushing and pulling.

Further, according to the slide mechanism 200C, indentation due to a ball plunger is reduced by the increase in hardness due to the change in material, and contamination of the surface of the beam splitter 150 caused by dust generation is suppressed.

### 8. Electronic Device Manufacturing Method

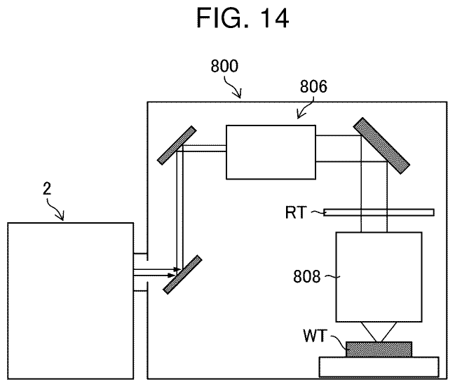

FIG. 14 schematically shows a configuration example of an exposure apparatus 800. The exposure apparatus 800 includes an illumination optical system 806 and a projection optical system 808. The laser device 2 generates laser light and outputs the laser light to the exposure apparatus 800. The illumination optical system 806 illuminates a reticle pattern of a reticle (not shown) arranged on a reticle stage RT with laser light incident from the laser device 2. The projection optical system 808 causes the laser light transmitted through the reticle to be imaged as being reduced and projected on a workpiece (not shown) arranged on a workpiece table WT. The workpiece is a photosensitive substrate such as a semiconductor wafer on which photoresist is applied.

The exposure apparatus 800 synchronously translates the reticle stage RT and the workpiece table WT to expose the workpiece to the laser light reflecting the reticle pattern. After the reticle pattern is transferred onto the semiconductor wafer by the exposure process described above, a semiconductor device can be manufactured through a plurality of processes. The semiconductor device is an example of the “electronic device” in the present disclosure.

### 9. Others

The description above is intended to be illustrative and the present disclosure is not limited thereto. Therefore, it would be obvious to those skilled in the art that various modifications to the embodiments of the present disclosure would be possible without departing from the spirit and the scope of the appended claims. Further, it would be also obvious to those skilled in the art that embodiments of the present disclosure would be appropriately combined.

The terms used throughout the present specification and the appended claims should be interpreted as non-limiting terms unless clearly described. For example, terms such as “comprise”, “include”, “have”, and “contain” should not be interpreted to be exclusive of other structural elements. Further, indefinite articles “a/an” described in the present specification and the appended claims should be interpreted to mean “at least one” or “one or more.” Further, “at least one of A, B, and C” should be interpreted to mean any of A, B, C, A+B, A+C, B+C, and A+B+C as well as to include combinations of any thereof and any other than A, B, and C.

What is claimed is:

1. An optical pulse stretcher comprising:
a beam splitter configured to separate laser light incident on an optical surface thereof into reflection laser light and transmission laser light;
a holder configured to fix the beam splitter with the optical surface of the beam splitter inclined with respect to an optical path axis of the incident laser light;
a plurality of mirrors configured to guide the reflection laser light to the beam splitter; and
a slide mechanism configured to move the beam splitter in a direction parallel to the optical surface,
the slide mechanism including:
a slide plate to which the holder is coupled; and
a case which holds the slide plate in a movable manner in a slide direction with respect to a base plate on which the plurality of mirrors are arranged,
the case including a threaded hole having an internal thread formed on an inner circumference thereof, and
the slide plate including a through hole at a position corresponding to the threaded hole.

2. The optical pulse stretcher according to claim 1,
wherein the case includes a plurality of the threaded holes, and
the slide plate includes a plurality of the through holes at positions corresponding to the plurality of threaded holes.

3. The optical pulse stretcher according to claim 1,
wherein a plurality of the threaded holes include a first threaded hole corresponding to a first position of the slide plate, and a second thread hole corresponding to a second position of the slide plate moved from the first position.

4. The optical pulse stretcher according to claim 3, further comprising a positioning mechanism configured to restrict a position of the slide plate in the slide direction,
wherein the positioning mechanism includes:
an engaged member including a plurality of recessed portions including a first recessed portion causing the slide plate to be located at the first position of the slide plate in the slide direction and a second recessed portion causing the slide plate to be located at the second position of the slide plate in the slide direction; and
a positioning plunger to be engaged with either one of the plurality of recessed portions.

5. The optical pulse stretcher according to claim 1,
wherein the through hole has an elongated hole shape extending in the slide direction.

6. The optical pulse stretcher according to claim 1,
wherein the slide plate is provided with a holder fixing screw configured to couple the holder to the slide plate.

7. The optical pulse stretcher according to claim 6,
wherein an axial center of the holder fixing screw is parallel to the optical surface.

8. The optical pulse stretcher according to claim 7, further comprising a plunger configured to urge the slide plate to the case,
wherein a force is applied to the slide plate in a direction away from the case owing to tightening of the holder fixing screw, and
the force in the direction away from the case is larger than a force of the plunger urging the case.

9. The optical pulse stretcher according to claim 1,
wherein the through hole is a non-threaded hole without having an internal thread formed on an inner circumference thereof.

10. The optical pulse stretcher according to claim 1,
further comprising a slide plate fixing screw configured to be fastened to the thread hole via the through hole.

11. The optical pulse stretcher according to claim 1, further comprising:
a rod movable in the slide direction; and
a transmission member configured to transmit displacement of the rod to the slide plate,
wherein the transmission member transmits the displacement of the rod in the slide direction and restricts transmission of displacement of the rod in a direction different from the slide direction.

12. The optical pulse stretcher according to claim 11,
wherein the transmission member includes:
a plate portion provided on the slide plate; and
a flange portion provided at the rod,
wherein the flange portion abuts against the slide plate or the plate portion in accordance with movement of the rod, and transmits the displacement of the rod in the slide direction to the slide plate.

13. The optical pulse stretcher according to claim 1,
wherein the slide plate includes:
a contact surface which comes into contact with the case;
a side surface in the slide direction of the slide plate; and
an inclined surface inclined with respect to the slide direction and connecting the contact surface and the side surface.

14. The optical pulse stretcher according to claim 13,
wherein an angle of the inclined surface with respect to the slide direction is 10 degrees or more and 45 degrees or less.

15. The optical pulse stretcher according to claim 13,
wherein the slide plate includes a curved surface having a radius of curvature between the contact surface and the inclined surface.

16. The optical pulse stretcher according to claim 15,
wherein the radius of curvature is 3 mm or more and 15 mm or less.

17. The optical pulse stretcher according to claim 1,
wherein material of the slide plate is stainless steel.

18. The optical pulse stretcher according to claim 17,
wherein the stainless steel is SUS440C.

19. A laser device comprising:
a pair of electrodes configured to cause discharge to occur; and
an optical pulse stretcher configured to extend a pulse width of pulse laser light generated by the discharge having occurred between the electrodes,
the optical pulse stretcher including:
a beam splitter configured to separate laser light incident on an optical surface thereof into reflection laser light and transmission laser light;
a holder configured to fix the beam splitter with the optical surface of the beam splitter inclined with respect to an optical path axis of the incident laser light;
a plurality of mirrors configured to guide the reflection laser light to the beam splitter; and
a slide mechanism configured to move the beam splitter in a direction parallel to the optical surface,
the slide mechanism including:
a slide plate to which the holder is coupled; and
a case which holds the slide plate in a movable manner with respect to a base plate on which the plurality of mirrors are arranged,
the case including a threaded hole, and
the slide plate including a through hole at a position corresponding to the threaded hole.

20. An electronic device manufacturing method, comprising:
generating laser light with a pulse width extended using a laser device;
outputting the laser light to an exposure apparatus; and
exposing a photosensitive substrate to the laser light in the exposure apparatus to manufacture an electronic device,
the laser device including:
a pair of electrodes configured to cause discharge to occur; and
an optical pulse stretcher configured to extend the pulse width of pulse laser light generated by the discharge having occurred between the electrodes,
the optical pulse stretcher including:
a beam splitter configured to separate the laser light incident on an optical surface thereof into reflection laser light and transmission laser light;
a holder configured to fix the beam splitter with the optical surface of the beam splitter inclined with respect to an optical path axis of the incident laser light;
a plurality of mirrors configured to guide the reflection laser light to the beam splitter; and
a slide mechanism configured to move the beam splitter in a direction parallel to the optical surface,
the slide mechanism including:
a slide plate to which the holder is coupled; and
a case which holds the slide plate in a movable manner with respect to a base plate on which the plurality of mirrors are arranged,
the case including a threaded hole, and
the slide plate including a through hole at a position corresponding to the threaded hole.
